(19) United States
(12) Patent Application Publication
(10) Pub. No.: US 2017/0265446 A1
(43) Pub. Date: Sep. 21, 2017

(54) Ice Hole Liner

(71) Applicant: Matthew Dungan, Rigby, ID (US)

(72) Inventor: Matthew Dungan, Rigby, ID (US)

(21) Appl. No.: 15/075,036

(22) Filed: Mar. 18, 2016

(51) Int. Cl. A01K 97/01; A01K 99/00; A01K 97/12

(52) U.S. Cl. CPC A01K 97/01; A01K 97/12; A01K 99/00

(57) ABSTRACT

Disclosed is an ice hole liner with a handle. The liner is placed in an ice hole during freezing conditions with the outer wall of the liner contacting the inner wall of the ice hole. When the surface of the ice hole freezes the liner is pulled out of the frozen ice hole which clears the hole of ice. The liner also serves as a stable base to which fishing devices and rod holders can be attached so a fish can't pull them down the ice hole.

### REFERENCES CITED

1. The Original Catch Hole Cover, www.catchcover.com
2. Ice Titan Hole Guard, You Tube, https://youtu.be/cuh3dDV_Tsl,
3. Facebook: Ice Fishing Ice Titan Hole Guard
4. U.S. Pat. No. 2,838,196 4-20-56 H. E. Chapman
5. U.S. Pat. No. 2,799,146 7-16-57 Meagher, William E. 249/66.1
6. U.S. Pat. No. 2,877,595 1-20-58 F. R. Stuart
7. U.S. Pat. No. 2,914,926 4-12-57 Meagher William E.
8. U.S. Pat. No. 2,883,784 9-12-57 R. E Obernolte
9. U.S. Pat. No. 3,056,272 A 5-23-60 E. F. Eilers 249/79
10. U.S. Pat. No. 3,813,891 6-4-74 Homer C. Wooten 62/260
11. U.S. Pat. No. 4,114,303 9-19-78 Richard C. Hedlund 43/4
12. U.S. Pat. No. 4,218,840 8-26-80 Robert J. Cohee 43/4
13. U.S. Pat. No. 4,438,757 9-13-81 Lyle C. Anderson 126/360
14. U.S. Pat. No. 4,747,226 5-31-88 Todd Harry V 43/4
15. U.S. Pat. No. 4,845,874 7-11-89 Yale Norwick 43/4
16. U.S. Pat. No. 6,694,662 2-24-2004 Mcclure Jeffery 43/4
17. U.S. Pat. No. 5,048,220 9-17-91 Dennis L. Harris 43/4
18. U.S. Pat. No. 4,662,099 5-5-1987 Stewart 43/4

### FIELD OF THE INVENTION

The invention relates generally to an apparatus for ice fishing, and more particularly to a device to manage ice build up inside an ice hole used for ice fishing. The invention also contains a bracket that an ice fishing device can be attached to.

### BACKGROUND OF THE INVENTION

This invention relates to ice fishing and more particularly to a device that facilitates the easy extraction of ice and fishing devices that are frozen into the ice of a frozen over ice hole. It also provides a secure base to which fishing devices can be attached so they can't be pulled down the ice hole by a hooked fish. Ice fishing is a sport in which a person cuts a hole in the ice on a frozen body of water and fishes for fish through the hole. This is mainly done by using a fishing hook and line with a tip up or rod and reel. Fisherman bait their hook and drop it down the ice hole on a fishing line to try to entice a fish to bite the hook. When a fish bites the fisherman gives a tug on the line to hook the fish and pull it up through the hole.

There are several devices which have been utilized to assist a fisherman in this activity. Some devices for ice fishing include a rod holder which holds the rod in place over the hole in the ice. Another device called a tip up releases a signaling flat when a fish has taken the bait. Hook setting devices set the hook in a fishes mouth when they bite. Tip down devices allow the fishing rod to move from a horizontal position to a tip down position when a fish tugs on the line. The effectiveness of these devices decreases when the fishing line or the device freezes into the ice hole. These devices can also be pulled down the ice hole by a fish tugging on the line.

What is needed is an improved ice hole liner that facilitates the safe, easy, and quick removal of ice and fishing line and fishing devices that are frozen into the ice of a frozen over ice hole. What is needed is a stable base to which different kinds of fishing devices can be attached to prevent them from being pulled down an ice hole by a fish tugging on the fishing line. What is needed is an ice hole liner that will allow an ice hole to retain its shape and form after the ice has been extracted from it. What is needed is an ice hole liner that provides a receptacle for a signaling flag to make it easy to locate the ice hole during snowy conditions. What is needed is an ice hole liner to elevate a tip up off the surface of the ice so it doesn't freeze into the slush and water on top of the ice. What is needed is an ice hole liner that can be stacked together with other ice hole liners to be more compact and aid in transport and storage.

### SUMMARY OF THE INVENTION

These and other goals are accomplished by the present invention. The invention is an ice hole liner that is used to extract ice and fishing devices and fishing line that get frozen into the ice when an ice hole freezes over. The liner is placed in the ice hole as soon as the hole is cut in the ice. Next the hook and line from a fishing device is dropped through the liner in the ice hole and positioned for fishing. Then the fishing device is positioned next to the ice hole or on top of the ice hole liner depending on what kind of fishing device is being used. When the ice hole freezes over and an ice fisherman wants to remove the ice from the hole, he simply lifts up on the handle and pulls the liner from the frozen over ice hole. Any ice that has formed within the walls of the liner is extracted from the hole easily and quickly along with the liner. A simple hit with a blunt object breaks the ice out of the liner and frees the fishing line or fishing device. What use to take a couple minutes of chipping ice manually out of a hole now takes seconds by using the liner. The original size and shape of the ice hole is also maintained. The liner can be placed back in the ice hole and fishing can resume until the ice fisherman chooses to clear the hole of ice again.

The device of the invention includes a hollow cylindrical tube with the top of the cylindrical tube being larger in diameter than the bottom of the tube. This shape allows the circular ice disc that forms inside the liner to not fall back down through the liner and back into the ice hole. This shape also allows multiple ice hole liners to be stacked within themselves to make it easier to transport and store them.

The ice hole liner contains guards that that extend upward and outward from the top portion of the liner. They keep a tip up from sliding around on the top surface of the ice hole liner when a big fish is tugging on the line. This prevents the tip up from sliding off of the top surface of the hole liner and into the ice hole so it's not lost. At least one of the guards contains an opening into which a hook setting device can be placed to secure the hook setting device to the ice hole liner to prevent it from being pulled down the ice hole and lost.

A handle is attached to the top portion of the cylindrical tube that allows an ice fisherman to get a firm grip on the ice hole liner in order to extract it from the ice hole. When a tip up is used with the ice hole liner it has to be placed under the handle. If the tip up is on top of the ice handle when it freezes into the ice the handle can't be raised up and used to pull the liner from the ice hole. It is assumed that an ice fisherman will forget this occasionally so an alternative means to extract the liner with an adequate gripping surface is provided. The guards that extend upward and outward from the top portion of the hole liner have gasping tabs which allows an ice fisherman to get a firm hold on the liner so it can be extracted from the ice.

Three longitudinal ribs are attached to the outer surface of the top portion of the ice hole liner. The ribs help hold the liner in place and keep the structures at the top portion of the liner above the surface of the ice so they don't freeze to or into the ice. This makes the ice hole liner easier to extract from a frozen over ice hole.

The ice hole liner contains a signal flag receptacle so an ice fisherman can easily put up a flag and mark where the tip up is. This allows them to easily find their tip up when visibility is bad when it is snowing or foggy outside. It also allows other fishermen riding around on a four wheeler or snow machine to see the tip up so they don't run over it. Sometimes tip ups can become completely covered with snow when left out over night and a flag prevents the tip up from being lost in this situation.

In one configuration of the ice hole liner an attachment bracket is provided where fishing devices can be attached to the ice hole liner. Rods in rod holders that are left sitting on the surface of the ice are commonly pulled down the ice hole by a fish pulling on the fishing line. Tip down devices, hook setting devices, and signaling devices, all could use better support on the surface of the ice so they don't get pulled down the ice hole. The ice hole liner provides a stable base and therefore an attachment bracket is provided so these devices can be secured to the ice hole liner to prevent them from being pulled down the ice hole and lost.

The ice hole liner is designed to be made out of a substance that repels water and ice. Some materials like bare metals actually form ice on them and stick to ice. If your hands are wet from touching a fish and you touch a frigid metal surface your hand can stick to it. Material like plastics repel water and don't accumulate ice on their surfaces. They don't stick to wet surfaces either which make them ideal for using in freezing conditions and using to make the ice hole liner out of.

The device of the invention has been described above including many of its different features and characteristics but I want to make known that the invention doesn't lie only in one particular feature or characteristic but rather the combination of features and characteristics that make it distinct and different from other ice hole liners included in the prior art.

### BRIEF DESCRIPTION OF THE DRAWINGS

FIG. 1 is a perspective view of an embodiment of the ice hole liner of the invention.

FIG. 2 is a perspective view of a tip up fishing device that is being used with the ice hole liner of the invention.

FIG. 3 is a side view of a cross section of a fishing rod and line in a rod holder that is being used with the ice hole liner of the invention.

FIG. 4 is a side view of a cross section of a fishing rod and line in a tip down fishing device that is being used with the ice hole liner of the invention.

FIG. 5 is a side view of a cross section of the ice hole liner of the invention frozen into an ice hole.

FIG. 6 is a side view of a cross section of the ice hole liner of the invention after it has been extracted from a frozen over ice hole.

FIG. 7 is a side view of a cross section of a tip up fishing device being used with the ice hole liner of the invention that is frozen into an ice hole.

FIG. 8 is a side view of a cross section of a tip up fishing device being used with the ice hole liner of the invention after it has been extracted from a frozen over ice hole.

FIG. 9 is a perspective view of a rod in a hook setting device that is being used with the ice hole liner of the invention.

FIG. 10 is a side view of a cross section of an embodiment of the ice hole liner of the invention that is being used with a round tip up fishing device.

### DETAILED DESCRIPTION OF THE DRAWINGS

While the invention is susceptible to various modifications and alternative constructions, certain illustrated embodiments thereof have been shown in the drawings and will be described below in detail. It should be understood however that there is no intention to limit the invention to the specific form disclosed, but on the contrary, the invention is to cover all modifications, alternative constructions, and equivalents falling within the spirit and scope of the invention as defined in the claims.

In the following description and in the figures, like elements are identified with like reference numerals. The use of “or” indicates a non exclusive alternative without limitation unless otherwise noted. The use of “including” means “including, but not limited to,” unless otherwise noted.

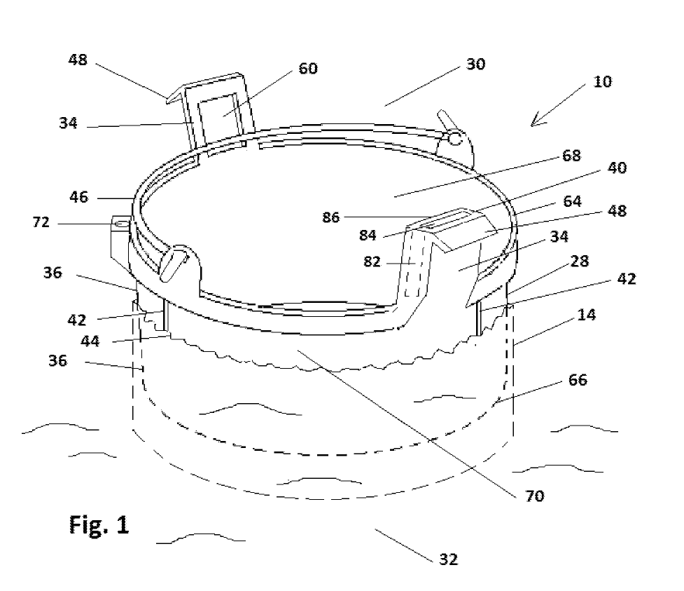

A preferred embodiment of the invention is shown in the figures. FIG. 1 shows the ice hole liner 10 of the invention. Shown in FIG. 1 is an ice hole 14 that has been cut into the ice with the ice hole liner 10 being placed in the ice hole 14. The ice hole liner consists of a hollow cylindrical body 28 with a top side 30 and a bottom side 32 with the top side 30 referring to the portion of the cylindrical body 28 that is above the top surface of the ice 44 when the ice hole liner 10 is in the ice hole 14. The cylindrical body 28 also contains a top edge 64 and a bottom edge 66, with an inside 68 and an outside 70, with the top side 30 being larger in diameter than the bottom side 32. Located at the top side 30 of the ice hole liner are guards 34 that extend in a generally upward and slightly outward direction from the walls 36 of the cylindrical body 28 of the ice hole liner 10. The guards having a medial edge 86 in relation to the hole liner 10 with the medial edge 86 of the guard 34 being lateral to and not in line with or medial to the inside 68 of the hole liner 10. A flag attachment receptacle 72 is also provided along with a handle 46. There are also longitudinal ribs 42 that are located on the lateral upper surface of the ice hole liner 10. These longitudinal ribs 42 are thin in nature and contact the top surface of the ice 44 and are the only structures that contact the top surface of the ice 44. This prevents any larger structures of the ice hole liner 10 from touching the top surface of the ice 44 and freezing into the ice. This makes extracting the ice hole liner 10 easier after being frozen into the ice hole 14.

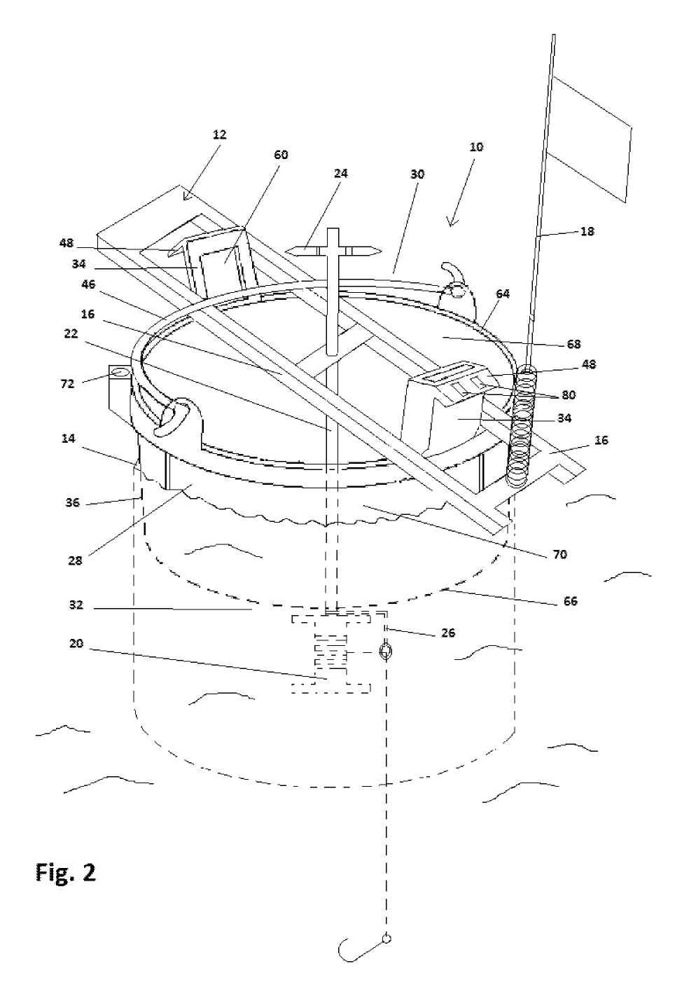

FIG. 2 shows the ice hole liner 10 of the invention. Shown in FIG. 2. is a tip up 12 which can be a separate device, or it can be a tip up that is built into the ice hole liner and comes with the ice hole liner when purchased. The ice hole liner 10 and the tip up 12 are used with a hole cut into a frozen lake with the hole being designated as 14. The tip up 12 includes a body 16, flag 18, spool with fishing line 20, shaft 22, spindle 24, and line guide 26. The hole liner includes a cylindrical body 28 with a top side 30 and a bottom side 32 and a top edge 64 and a bottom edge 66, and an inside 68 and an outside 70. Located at the top side 30 of the ice hole liner are guards 34 that extend in a generally upward and slightly outward direction from the walls 36 of the cylindrical body 28 of the ice hole liner 10. These guards 34 fit within the body 16 of the tip up 12 which keeps the tip up 12 from sliding off the top edge of the ice hole liner 64 and into the ice hole 14. A handle 46 is provided to grab onto in order to pull and extract the ice hole liner 10 from the ice hole 14. The handle 14 can raise and lower so that the handle 14 can be placed on top of the tip up 12. If the handle 46 is underneath the tip up 12 when it freezes into the ice hole 14, the handle can become struck underneath the tip up 12 and can't be grabbed to be used to extract the hole liner 10 with. It would be easy for an ice fisherman to forget to put the tip up 12 below the handle 46, so alternative grasping tabs 48 are attached to the guards 34. An ice fisherman can grab the hole liner 10 by the grasping tabs 48 in order to get a good grip on the liner 10 to pull the ice hole liner 10 out of a frozen ice hole. Two slots 80 are located in the grasping tabs 48 to provide a secure spot where the tip up 12 or any other fishing device that is used with the hole liner 10 can be tied to for additional security. Subsequently the slots 80 could be located on different areas of the hole liner 10 with the same effect.

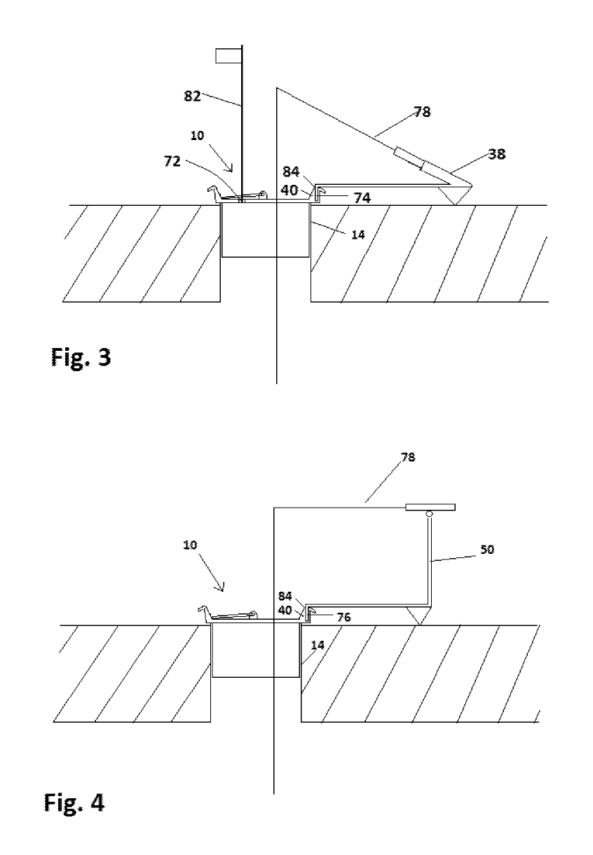

FIG. 3 shows the ice hole liner 10 with a rod holder 38 attached to the ice hole liner 10 by the attachment bracket 40 that is located adjacent to the top portion of the ice hole liner. The rod holder 38 is being used with a rod and line 78. You can see that the rod holder 38 is a separate device that has an attachment bracket connection 74. The rod holder 38 can be securely fixed to the ice hole liner by placing the attachment bracket connection 74 of the rod holder 38 into the attachment bracket 40 of the ice hole liner 10. In this embodiment the attachment bracket 40 contains a rectangular shaped cavity 82 as seen in FIG. 1 created by the walls of the attachment bracket 40. In FIG. 3 you can see the cavity 82 serves as a receptacle where the attachment bracket connection 74 of the rod holder 38 can plug into. In FIG. 3 the attachment bracket connection 74 is shown connecting into the attachment bracket 40 in a downward fashion with the opening in the attachment bracket 40 being positioned upward. An alternative construction could have the opening in the attachment bracket 84 opening to the side instead of upward. In this position the attachment bracket connection 74 of the rod holder 38 could be configured to attach to the attachment bracket 40 from the side. There could be many variations and alternative constructions of the attachment bracket 40 and attachment bracket connection 74 that could provide a good connection between the hole liner 10 and the rod holder 38. The rod holder 38 can also detach from the ice hole liner 10 at the rod holding bracket 40 to make the device more compact for transport and storage.

You can see that the attachment bracket 40 is a part of one of the guards 34. The attachment bracket 40 could also be constructed separate from the guard 34 on the top edge of the device body 64 or on the upper portion of the outside wall 36 or anywhere proximal or adjacent to the top side of the ice hole liner 10 that is lateral to the inside of the ice hole liner 10. FIG. 3 also shows the use of a signaling flag 82 with the signaling flag receptacle 72 that an ice fisherman can use to mark and locate the whereabouts of the ice hole.

FIG. 4 shows the ice hole liner 10 with a tip down fishing device 50 that is being used with a rod and line 78. As you can see in the drawings the tip down device 50 is a separate device that can be attached to the ice hole liner 10 by the attachment bracket 40. The tip down device 50 contains an attachment bracket connection 76 that fits into the attachment bracket 40 to rigidly connect the tip down device 50 to the ice hole liner 10. Normally tip down devices sit on the surface of the ice beside the ice hole and can be pulled down the ice hole with a big tug on the fishing line by a large fish. The ice hole liner 10 provides a solid base for the tip down device 50 so it can't be pulled down the ice hole 14.

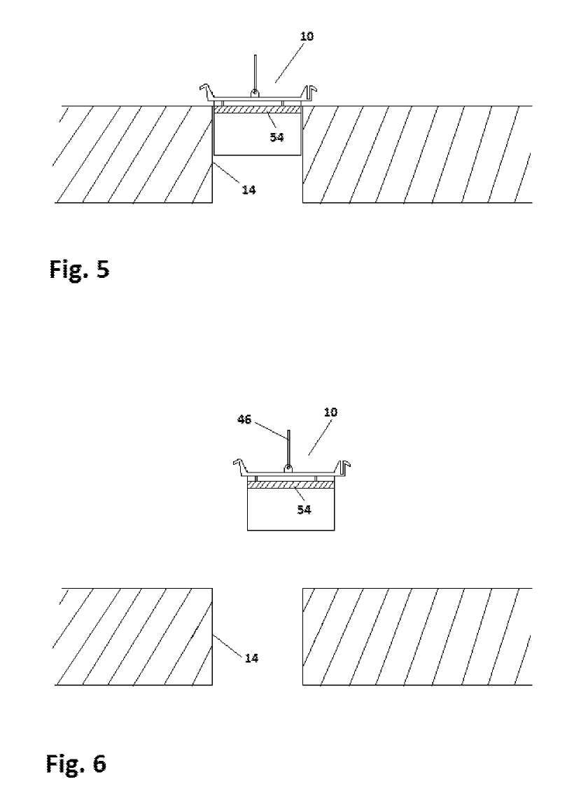

FIG. 5 shows the ice hole liner 10 placed in a hole cut in the ice 14. The ice hole liner has been left in place during freezing conditions and an ice cap 54 has formed within the hole liner 10. You can see that the ice the ice hole 14 is cut into is thicker than the ice 54 that has formed in the ice hole liner 10 since it has been forming for a long period of time.

FIG. 6 shows the ice hole liner 10 that was allowed to freeze into the ice hole 14 after it has been extracted from the frozen over ice hole 14 by the ice hole liners handle 46. The ice cap 54 that formed within the ice hole liner 10 has been extracted along with the ice hole liner 10 when it was pulled out of the frozen over ice hole 14. Now the ice hole 14 is clear of ice and ready to be fished through again.

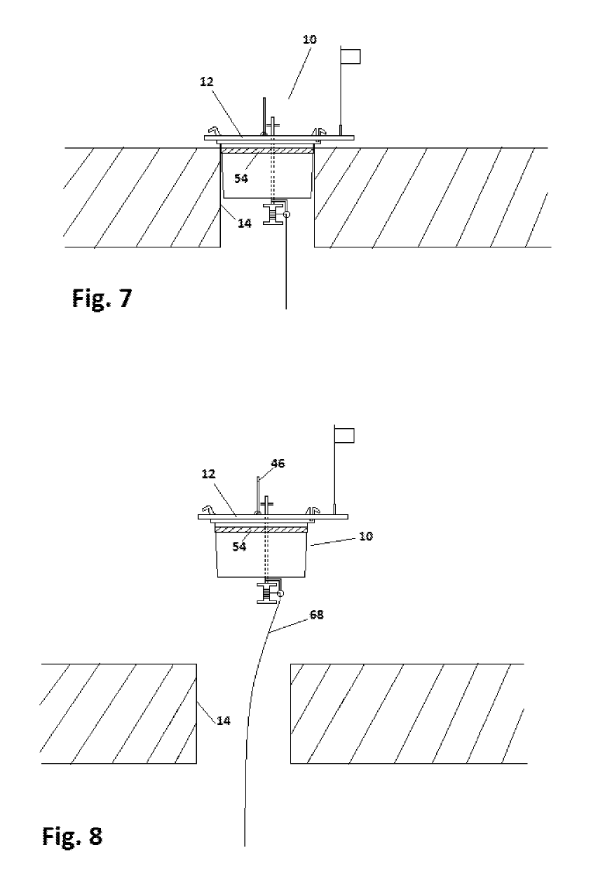

FIG. 7 shows a tip up fishing device 12 being used with the ice hole liner 10. The ice hole liner 10 has been placed inside the ice hole 14 and the tip up fishing device 12 has been placed on top of the ice hole liner 10 and allowed to freeze into place. The ice hole has frozen over and a cap of ice 54 has frozen the tip up 12 into the ice hole 14. The tip up 12 is designed to still work properly in a frozen over ice hole 14 but without the hole liner 10 the tip up has to be chipped out of the frozen over ice hole 14 manually which can take time, be tedious work, and could risk the tip up being hit with the ice chipping tool and being damaged.

FIG. 8 shows the ice hole liner 10 used with the tip up 12 after it has been extracted from the frozen over ice hole 14. By pulling on the handle 46 of the ice hole liner, the ice hole liner 10 and tip up 12 have been extracted quickly and easily from the frozen over ice hole 14. Now the fishing line 68 can be grabbed and a fish on the end of the line can be pulled in through the open hole in the ice. The ice cap 54 that formed within the ice hole liner 10 has been extracted along with the ice hole liner. The original size and shape of the ice hole 14 has been maintained to ensure that as large a fish as possible can be pulled up through the open ice hole. Lots of tip ups have been hit and damaged as a result of being hit while being chipped out of a frozen over ice hole. The ice hole liner 10 facilitates the quick and easy extraction of the tip up fishing device 12 by simply pulling on the handle 46 of the ice hole liner 10.

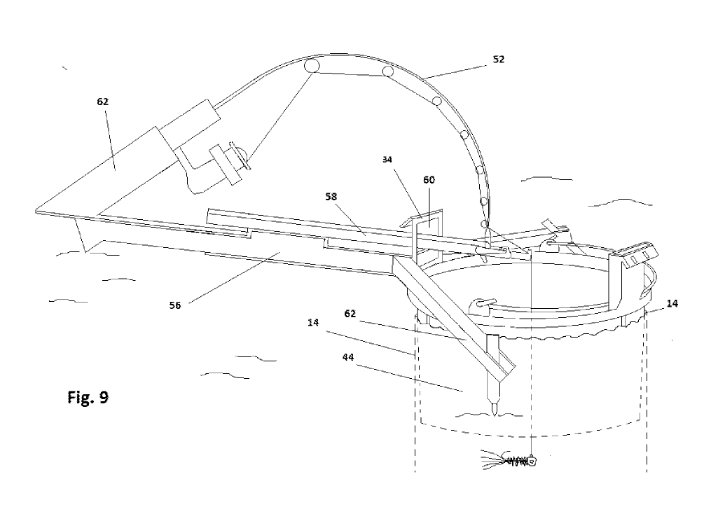

FIG. 9 shows a hook setting device 56 where the trigger slide 58 of the hook setting device 56 is positioned in the opening 60 of a guard 34. When the trigger slide 58 is placed in the opening 60 it prevents the side to side movement of the trigger slide 58 which in turn stabilizes the hook setting device 56 upon the surface of the ice 44. Excessive pressure from a large fish pulling on the line can cause the hook setting 56 to be pulled around on the surface of the ice 44. A leg 62 of the hook setting device 56 can subsequently be dislodged from the surface of the ice 44 and fall into the ice hole 14 which could cause the hook setting device 56 to tip over and become unstable on the surface of the ice 44. In this situation the rod 52 could be pulled out of the rod holder 62 of the hook setting device 56 and get pulled down the ice hole 44 and lost. By placing the trigger slide 58 in the opening 60 in the guard 34 the hook setting device 56 is better stabilized upon the surface of the ice 44.

The guard 34 shown in FIG. 9 serves the dual purpose of being a guard to protect against a tip up 34 being pulled down into the ice hole when it is placed on top of the guard 34 as show in FIG. 2 and also as a structure that an opening 60 can be formed into in which the trigger slide 58 of the hook setting device 56 can be placed to help secure it. Another purpose the guard 34 can serve is to be a structure that the attachment bracket 40 can be constructed into as outlined in FIG. 1. The guard 34 can be made to where it has sufficient height and size to provide all of these purposes.

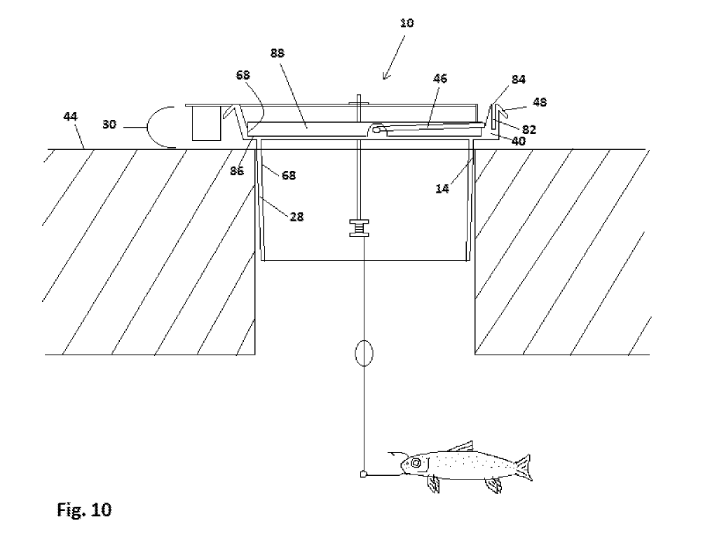

FIG. 10 shows a cross section of another embodiment of the ice hole liner 10 which contains a flange 86 in the inside of the hollow cylindrical body 68 at its top side 30. The top side of the cylindrical body 30 consisting of the portion of the hollow cylindrical body 28 that is above the surface of the ice 44 when the ice hole liner 10 is in use. Some ice fishermen like to use round circular tip ups 88 that fit over the top of the ice hole 14. These round tip ups 88 are designed to insulate the ice hole 14 but can freeze into the slush and or to the top of the ice 44 onto which they are placed and have to be chipped out. If the tip up 88 was placed on top of the ice hole liner 10 it would prevent this. The diameter of these round style tip ups is slightly to big to fit well on top of the ice hole liner. So in the embodiment in FIG. 10 the inside of the device body 68 at its top side 30 has been enlarged slightly so the round style of tip up can fit easily and securely into the enlarged area. This enlargement in the inside of the device body 68 creates a flange 86 where the diameter of the inside of the device body 68 widens out quickly and then continues to rise upward again.

The exemplary embodiments shown in the figures and described above illustrate but do not limit the invention. It should be understood that there is no intention to limit the invention to the specific form disclosed; rather, the intention is to cover all modifications, alternative constructions, and equivalents falling within the spirit and scope of the invention as defined in the claims. Hence, the foregoing description should not be construed to limit the scope of the invention, which is defined in the following claims.

While there is shown and described the present preferred embodiments of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

What is claimed is:

1. An ice hole liner consisting of a hollow cylindrical body with a top side and a bottom side, with the top side being larger in diameter than the bottom side, with the cylindrical body having an inside and outside, and a handle attached to the top side of the cylindrical body, and at least one guard attached to the top side of the cylindrical body, with the medial edge of the guard being in line with or lateral to the inside of the cylindrical body, with the ice hole liner configured to be placed inside an ice hole and left to freeze inside the ice hole and then be extracted from the ice hole by its handle and take the ice out of the hole that formed within the ice hole.

2. The ice hole liner of claim number 1 in which the guard is able to fit inside the frame of a tip up fishing device in order to better secure it to the top side of the ice hole liner and multiple guards can be attached to the top side of the cylindrical body.

3. The ice hole liner of claim number 1 in which the inside of the top side of the hollow cylindrical body contains a flange.

4. The ice hole liner of claim number 1 in which multiple ice hole liners can be stacked within themselves to be more compact to aid in transport and storage.

5. The ice hole liner of claim number 1 in which the top side of the cylindrical body contains a bracket that ice fishing devices can attach to, with the medial edge of the attachment bracket being lateral to the inside of the cylindrical body.

6. The ice hole liner of claim number 1 in which the guard contains a grasping tab which makes the guard easier to hold onto so it can be used to pull the liner from a frozen ice hole by the guard.

7. The ice hole liner of claim number 1 in which the ice hole liner contain at least one or more slots that can be used to tie a fishing device to the ice hole liner with in order to better secure it to the hole liner.

8. The ice hole liner of claim number 1 in which the guard can contain an opening.

9. The ice hole liner of claim number 1 in which there are longitudinal ribs attached to the outer surface of the top side of the cylindrical body.

10. The ice hole liner of claim number 1 in which the liner contains a receptacle for attaching a signaling flag.

11. The ice hole liner of claim number 1 in which the handle can raise and lower and is jointed where it attaches to the top of the hole liner.

12. An ice hole liner consisting of a hollow cylindrical body with a top side and a bottom side with the top side being larger in diameter than the bottom side, with the cylindrical body having an inside and an outside, with a fishing device attachment bracket attached to the top side of the cylindrical body, with the medial edge of the fishing device attachment bracket being in line with or lateral to the inside of the cylindrical body, with the ice hole liner configured to be placed inside an ice hole and left to freeze inside the ice hole and then be extracted from the ice hole by its handle and take the ice out of the hole that formed within the ice hole liner.

13. The ice hole liner of claim number 12 in which devices intended to be used to aid in catching fish through an ice hole can be attached to the attachment bracket to secure them and keep them from falling down an ice hole and being lost while they are in use upon the surface of the ice.

14. The ice hole liner of claim number 12 in which fishing devices can be configured to contain an attachment bracket connection by which they can be attached to the attachment bracket of the ice hole liner.

15. The ice hole liner of claim number 12 in which the hollow cylindrical body has a handle attached to the top side of the cylindrical body.

16. The ice hole liner of claim number 12 in which there are longitudinal ribs attached to the outer surface of the top side of the cylindrical body.

17. The ice hole liner of claim number 12 in which the liner is shaped so that multiple ice hole liners can be stacked within themselves to be more compact to aid in transport and storage.

18. The ice hole liner of claim number 12 in which the liner contains a receptacle for attaching a signaling flag.

19. The ice hole liner of claim number 12 in which the liner can contain multiple attachment brackets.

20. The ice hole liner of claim number 12 in which the inside of the top side of the hollow cylindrical body contains a flange
